(19) United States
(12) Patent Application Publication
(10) Pub. No.: US 2019/0149363 A1
(43) Pub. Date: May 16, 2019

(54) CHANNEL ESTIMATION CIRCUIT AND ASSOCIATED CHANNEL ESTIMATION METHOD

(71) Applicant: MStar Semiconductor, Inc., Hsinchu Hsien (TW)

(72) Inventors: Tzu-Yi Yang, Hsinchu County (TW); Ko-Yin Lai, Hsinchu County (TW); Tai-Lai Tung, Hsinchu County (TW)

(21) Appl. No.: 15/969,961

(22) Filed: May 3, 2018

(30) Foreign Application Priority Data
Nov. 10, 2017 (TW) 106138901

(51) Int. Cl. H04L 25/02; H04J 11/00

(52) U.S. Cl. CPC H04L 25/0204; H04J 11/005; H04L 25/0224

(57) ABSTRACT

A channel estimation circuit includes a pilot buffer, an interference indication buffer and a channel information calculation circuit. The pilot buffer stores channel information of multiple pilot cells in multiple symbols. The interference indication buffer stores interference indication information, which indicates whether the multiple symbols are affected by interference. The channel information calculation circuit, coupled to the pilot buffer and the interference indication buffer, estimates, based on channel information of a part of the multiple pilot cells in the multiple symbols, channel information of a data cell in the multiple symbols according to the interference indication information. The part of the multiple pilot cells do not include pilot cells of any symbol affected by interference.

This application claims the benefit of Taiwan application Serial No. 106138901, filed Nov. 10, 2017, the subject matter of which is incorporated herein by reference.

### BACKGROUND OF THE INVENTION

### Field of the Invention

The invention relates to channel estimation, and more particularly to a channel estimation circuit and a channel estimation method applied to a display device.

### Description of the Related Art

In the Digital Video Broadcasting-Second Generation Terrestrial (DVB-T2) standard, impulsive interference is regarded as an issue that severely affects image display. Impulsive interference has large sudden and periodical amplitudes, and is usually generated by factors in the ambient environment, e.g., an operating washing machine or dishwasher, and a fast automobile passing by. Due to the impulsive interference, a channel estimation circuit in a display device may generate incorrect estimated channel information, leading to subsequent signal processing errors.

### SUMMARY OF THE INVENTION

It is an object of the present invention to provide a channel estimation circuit and a channel estimation method applied to a display device so as to eliminate a part affected by impulsive interference and to solve issues of the prior art.

A channel estimation circuit is disclosed according to an embodiment of the present invention. The channel estimation circuit includes a pilot buffer, an interference indication buffer and a channel information calculation circuit. The pilot buffer stores channel information of multiple pilot cells in multiple symbols. The interference indication buffer stores interference indication information, which indicates whether the multiple symbols are affected by interference. The channel information calculation circuit, coupled to the pilot buffer and the interference indication buffer, estimates, based on channel information of a part of the multiple pilot cells in the multiple symbols, channel information of a data cell in the multiple symbols according to the interference indication information. The part of the multiple pilot cells do not include pilot cells of any symbol affected by the interference.

A channel estimation method is disclosed by another embodiment of the present invention. The channel estimation method includes: storing channel information of multiple pilot cells in multiple symbols in a pilot buffer; storing interference indication information in an interference indication buffer, wherein the interference indication information indicates whether the multiple symbols are affected by interference; and estimating, based on channel information of a part of the multiple pilot cells in the multiple pilot cells stored in the pilot buffer, channel information of a data cell in the multiple symbols according to the interference indication information. The part of the multiple pilot cells do not include pilot cells of any symbol affected by the interference.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1. is a block diagram of a channel estimation circuit according to an embodiment of the present invention;

FIG. 2 is a block diagram of a channel information calculation circuit according to an embodiment of the present invention;

FIG. 3 is a schematic diagram of operation of a selecting circuit and an interpolating circuit according to an embodiment of the present invention;

FIG. 4 is a schematic diagram operation of a selecting circuit and an interpolating circuit according to another embodiment of the present invention;

FIG. 5 is a block diagram of a receiver according to an embodiment of the present invention; and

FIG. 6 is a flowchart of a channel estimation method according to an embodiment of the present invention.

### DETAILED DESCRIPTION OF THE INVENTION

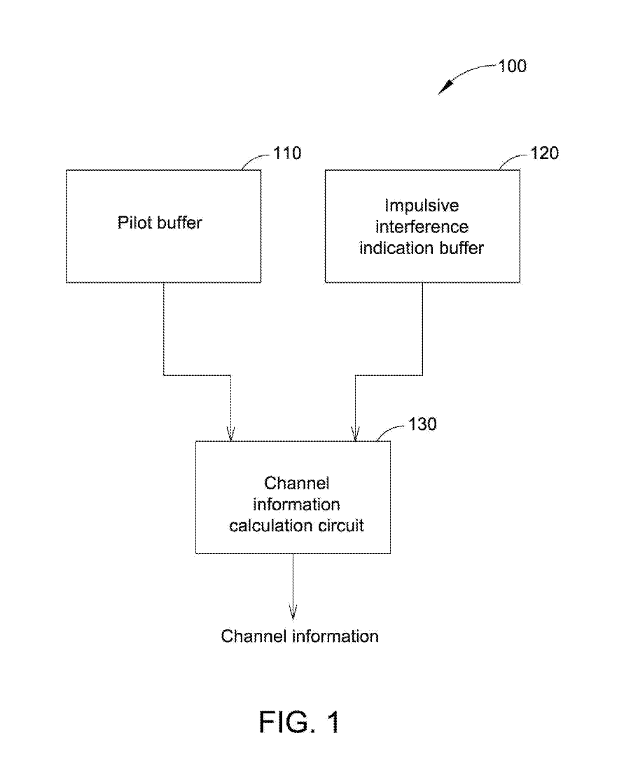

FIG. 1 shows a block diagram of a channel estimation circuit 100 according to an embodiment of the present invention. As shown in FIG. 1, the channel estimation circuit 100 includes a pilot buffer 110, an impulsive interference indication buffer 120 and a channel information calculation circuit 130. In this embodiment, the channel estimation circuit 100 is provided in a receiver of a television or a set-top box (STB), and the receiver is capable of receiving signals of orthogonal frequency-division multiplexing (OFDM) modulation, e.g., television signals compliant with DVB-T2.

In the channel estimation circuit 100, the pilot buffer 110 sequentially stores channel information of pilot cells in multiple symbols generated by a front-end circuit. The channel information includes amplitudes and phases corresponding to the pilot cells. The impulsive interference indication buffer 120 sequentially stores detection results, which are generated by an impulsive interference detection circuit and indicate which symbols of the multiple symbols are affected by impulsive interference. The channel information calculation circuit 130 estimates, based on the channel information of a part of the multiple pilot cells stored in the pilot buffer 110, channel information (e.g., frequency response) of a multiple data cells in the multiple symbols. The part of the multiple pilot cells do not include pilot cells of any symbol affected by impulsive interference. As previously described, because the pilot cells affected by impulsive interference are eliminated when the channel information calculation circuit 130 calculates the channel information of the multiple data cells, the channel information obtained is more accurate.

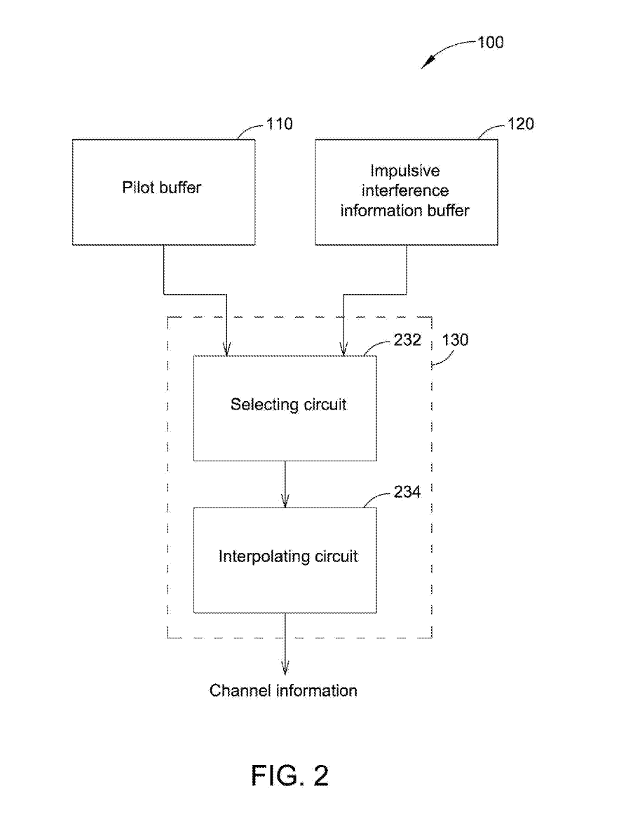

Referring to FIG. 2, in one embodiment, the channel information calculation circuit 130 includes a selecting circuit 232 and an interpolating circuit 234. In the operation of the embodiment, for one data cell, the selecting circuit 232 selects from the pilot buffer 110 the channel information of multiple adjacent pilot cells adjacent to the data cell, and refers to the detection results stored in the impulsive interference indication buffer 120 to select the channel information of at least a part of the multiple adjacent pilot cells. The at least a part of adjacent pilot cells selected do not include pilot cells of any symbol affected by impulsive interference. The interpolating circuit 234 performs interpolation according to the channel information of the at least a part of the adjacent pilot cells to calculate the channel information of the data cell. Two examples are given for explaining operation details of the selecting circuit 232 and the interpolating circuit 234.

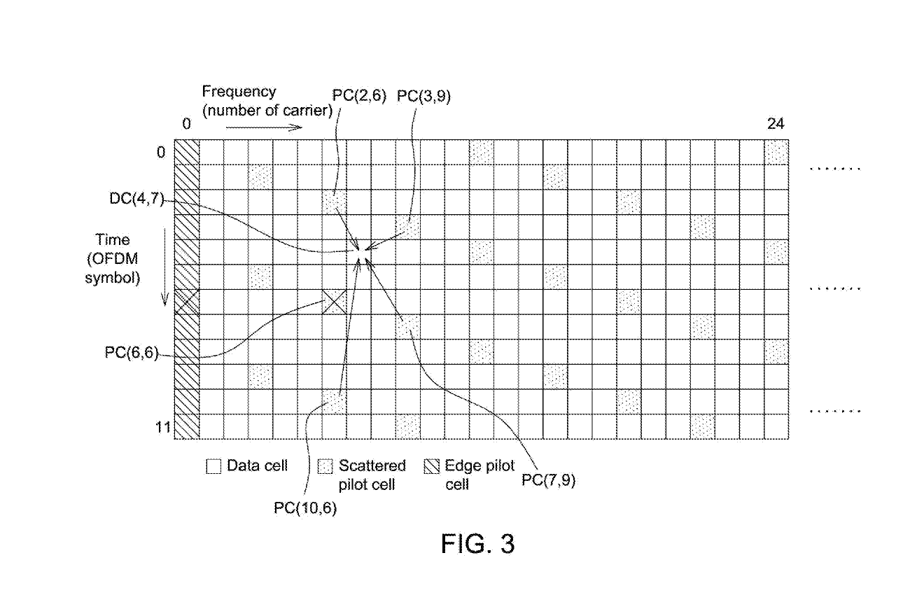

FIG. 3 shows a schematic diagram of the operation of the selecting circuit 232 and the interpolating circuit 234 according to an embodiment of the present invention. In FIG. 3, the vertical axis represents OFDM symbols at different time points, each row represents one OFDM symbol, and each OFDM symbol includes one edge pilot cell, multiple data cells and multiple scattered pilot cells; the horizontal axis represents frequency, and the columns respectively correspond to different carriers. In this embodiment, assuming that the channel estimation circuit 100 is to calculate the channel information of the data cell DC(4, 7), the selecting circuit 232 then obtains from the pilot buffer 110 four pilot cells PC(2, 6), PC(3, 9), PC(6, 6) and PC(7, 9) around the data cells DC(4, 7). At this point, the selecting circuit 232 also obtains from the impulsive interference indication buffer 120 information associated with symbols affected by impulsive interference. As shown in FIG. 3, assuming that the impulsive interference indication buffer 120 indicates that the symbol numbered 6 is affected by impulsive interference, the selecting circuit 232 then eliminates the pilot cell PC(6, 6), and uses another pilot cell (e.g., the pilot cell PC(10, 6)) near the pilot cell PC(6, 6) as a replacement of the eliminated pilot cell PC(6, 6). In conclusion, the selecting circuit 232 eventually transmits the channel information of the four pilot cells PC(2, 6), PC(3, 9), PC(10, 6) and PC(7, 9) to the interpolating circuit 234. The interpolating circuit 234 then performs an averaging or weighted addition operation on the channel information of the four pilot cells PC(2, 6), PC(3, 9), PC(10, 6) and PC(7, 9) to generate the channel information of the data cell DC(4, 7),

It should be noted that, the example shown in FIG. 3 is only for illustrating the operation of the selecting circuit 232 and the interpolating circuit 234, and the exemplary quantity of the pilot cells and the selection range of the pilot cells are not to be construed as limitations to the present invention. In other embodiments of the present invention, the selecting circuit 232 may regard the data cell DC(4, 7) as a center and obtain the channel information of all pilot cells of 15*15 grids around the data cell DC(4, 7), but only selects the closest N pilot cells (with the part affected by impulsive interference eliminated) as its output, where N may be any appropriate positive integer. Further, in this embodiment, the quantity (N) of the pilot cells outputted from the selecting circuit 232 to the interpolating circuit 234 may be constant.

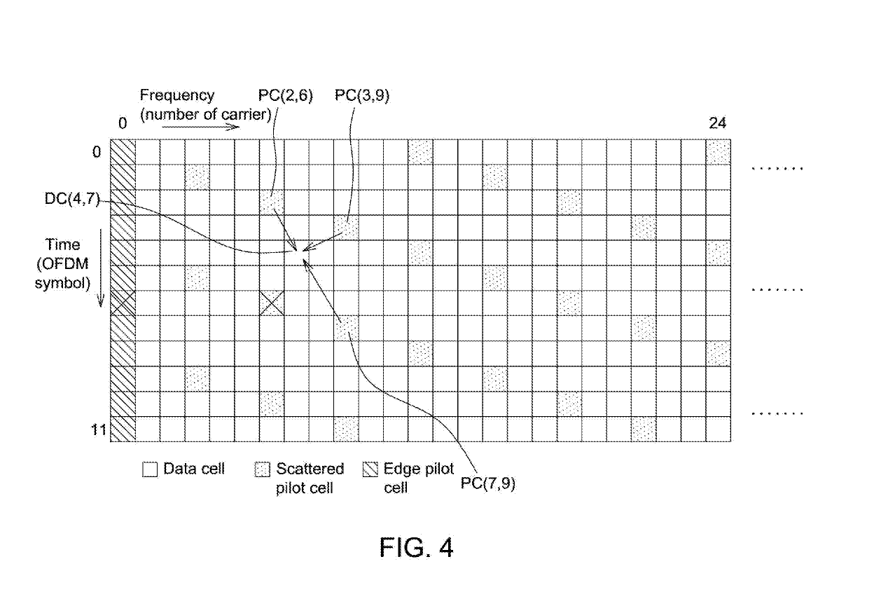

FIG. 4 shows a schematic diagram of the operation of the selecting circuit 232 and the interpolating circuit 234 according to another embodiment of the present invention. In FIG. 4, assuming that the channel estimation circuit 100 is to calculate the channel information of the data cell DC(4, 7), the selecting circuit 234 then obtains from the pilot buffer 110 four pilot cells PC(2, 6), PC(3, 9), PC(6, 6) and PC(7, 9) around the data cell DC(4, 7). At this point, the selecting circuit 232 also obtains from the impulsive interference indication buffer 120 information associated with the symbols affected by impulsive interference. As shown in FIG. 4, assuming that the impulsive interference indication buffer 120 indicates that the symbol numbered 6 is affected by impulsive interference, the selecting circuit 232 eliminates the pilot cell PC(6, 6), and directly transmits the channel information of the remaining three pilot cells PC(2, 6), PC(3, 9) and PC(7, 9) to the interpolating circuit 234. Next, the interpolating circuit 234 performs an averaging or weighted addition operation on the channel information of the pilot cells PC(2, 6), PC(3, 9) and PC(7, 9) to generate the channel information of the data cell DC(4, 7).

It should be noted that, the example shown in FIG. 4 is only for illustrating the operation of the selecting circuit 232 and the interpolating circuit 234, and the exemplary quantity of the pilot cells and the selection range of the pilot cells are not to be construed as limitations to the present invention. In other embodiments of the present invention, the selecting circuit 232 may regard the data cell DC(4, 7) as a center and obtain the channel information of all pilot cells of 15*15 grids around the data cell DC(4, 7), eliminate the symbols affected by impulsive interference therefrom, and transmit the channel information of the remaining pilot cells to the interpolating circuit 234, where N may be any appropriate positive integer. Further, in this embodiment, the quantity of the pilot cells outputted from the selecting circuit 232 to the interpolating circuit 234 is not a constant value, but changes according to whether a part of the adjacent pilot cells are affected by impulsive interference.

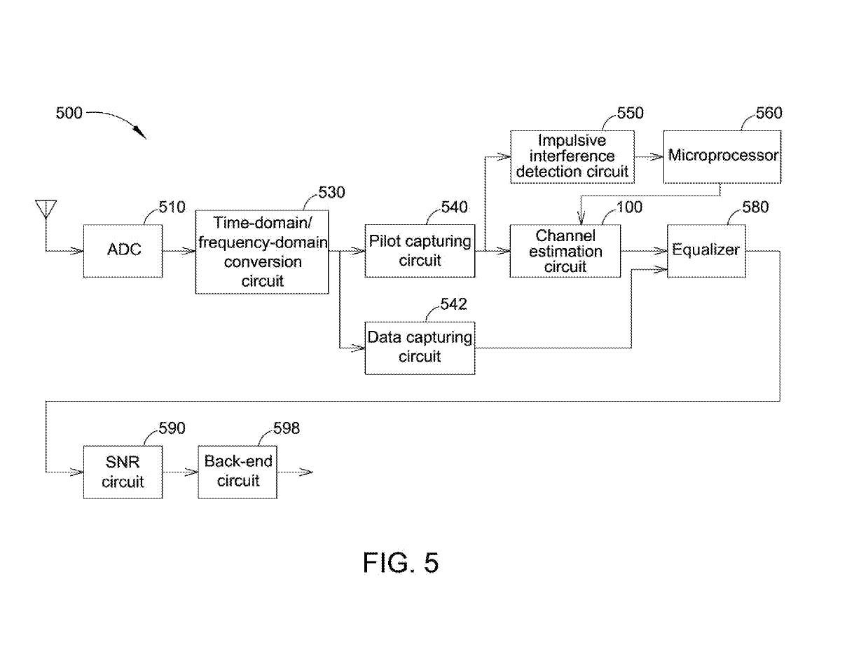

The channel estimation circuit 100 shown in FIG. 1 and FIG. 2 are applicable to a receiver. FIG. 5 shows a schematic diagram of a receiver 500 according to an embodiment of the present invention. As shown in FIG. 5, the circuit 500 include an analog-to-digital converter (ADC) 510, a time-domain/frequency-domain conversion circuit 530, a pilot capturing circuit 540, a data capturing circuit 542, an impulsive interference detection circuit 550, a microprocessor 560, a channel estimation circuit 100, an equalizer 580, a signal-to-noise ratio (SNR) estimation circuit 590, and a back-end circuit 598. In this embodiment, the receiver 500 receives and processes an analog input signal from an antenna, and generates an output signal for a television or an STB to play on a screen.

In the receiver 500, the ADC 510 processes the received analog input signal to generate a digital input signal. The time-domain/frequency-domain conversion circuit 530 converts the digital input signal from the time domain to the frequency domain to generate a frequency-domain signal, and may be implemented by a fast Fourier transform (FFT) operation. The structure of the time-domain signal may be referred from the content shown in FIG. 3 and FIG. 4.

The pilot capturing circuit 540 captures multiple pilot cells in each symbol from the frequency-domain signal. Because the frequency-domain signal outputted by the time-domain/frequency-domain conversion circuit 540 includes amplitude and phase information of pilot cells, the pilot capturing circuit 540 can directly obtain the channel information of the pilot cells, and store the channel information in the pilot buffer 110 in the channel estimation circuit 100. The impulsive interference detection circuit 550 determines whether each symbol is affected by impulsive interference according to the noise intensity of the channel information of the multiple pilot cells to generate a detection result, and stores the detection result via the microprocessor 560 in the impulsive interference indication buffer 120 in the channel estimation circuit 100. Next, the channel estimation circuit 100 calculates the channel information corresponding to all data cells in each symbol in the frequency-domain signal (referring to content shown in FIG. 1 to FIG. 4). Further, the data capturing circuit 542 captures multiple data cells in each symbol from the frequency-domain signal, and the equalizer 580 performs equalization on the multiple data cells according to the channel information calculated by the channel estimation circuit 100 to generate an equalized signal. The SNR estimation circuit 590 performs SNR estimation on the equalized signal to generate an estimated SNR result, and provides the estimated SNR result to the microprocessor 560 as a reference for signal processing. The back-end circuit 598 performs de-interleaving, de-mapping and decoding operations on the equalized signal to generate an output signal for a television or an STB to play.

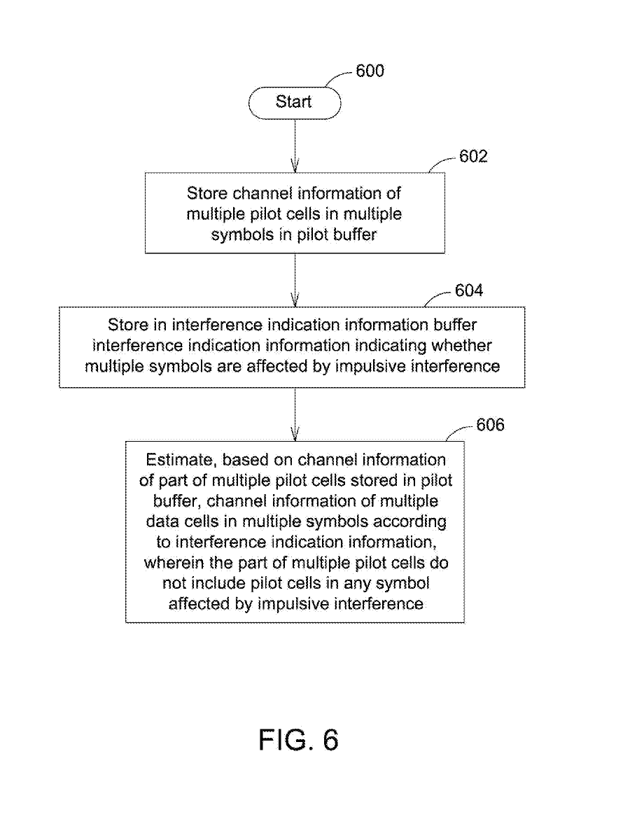

FIG. 6 shows a flowchart of a channel estimation method according to an embodiment of the present invention. Referring to FIG. 1 to FIG. 5 as well as the content disclosed above, the process in FIG. 6 are as below.

In step 600, the process begins.

In step 602, channel information of multiple pilot cells in multiple symbols are stored in a pilot buffer.

In step 604, interference indication information indicating whether the multiple symbols are affected by impulsive interference is stored in an impulsive interference indication buffer.

In step 606, channel information of multiple data cells in the multiple symbols is estimated based on the channel information of a part of the multiple pilot cells stored in the pilot buffer. The part of the multiple pilot cells do not include pilot cells of any symbol affected by impulsive interference.

In summary, in the channel estimation circuit of the present invention, an impulsive interference indication buffer is provided to indicate which symbols are affected by impulsive interference. Thus, when the channel estimation circuit calculates the channel information of data cells, the pilot cells affected by interference can be eliminated, so as to prevent the calculated channel information from the influence of impulsive interference, providing more accurate channel information for the use of a subsequent circuit.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A channel estimation circuit, comprising:
a pilot buffer, storing channel information of a plurality of pilot cells in a plurality of symbols;
an interference indication buffer, storing interference indication information, which indicates whether the plurality of symbols are affected by interference; and
a channel information calculation circuit, coupled to the pilot buffer and the interference indication buffer, estimating, based on the channel information of a part of the plurality of pilot cells, channel information of a data cell in the plurality of symbols according to the interference indication information, wherein the part of the plurality of pilot cells do not include pilot cells of any symbol affected by interference.

2. The channel estimation circuit according to claim 1, wherein the channel information calculation circuit comprises:
a selecting circuit, coupled to the pilot buffer and the interference indication buffer, for the data cell, the selecting circuit selecting from the pilot buffer the channel information of a plurality of adjacent pilot cells of the data cell, and referring to the interference indication information stored in the interference indication buffer to select the channel information of a part of the plurality of adjacent pilot cells, wherein the selected part of the adjacent pilot cells do not include pilot cells of any symbol affected by interference; and
an interpolating circuit, performing interpolation according to the channel information of the part of the plurality of adjacent pilot cells to calculate the channel information of the data cell.

3. The channel estimation circuit according to claim 2, wherein the selecting circuit selects from the plurality of adjacent pilot cells the channel information of a constant quantity of the adjacent pilot cells as the channel information of the part of the plurality of adjacent pilot cells.

4. The channel estimation circuit according to claim 3, wherein the constant quantity of the adjacent pilot cells is N; and when the N adjacent pilot cells include a predetermined pilot cell in a symbol affected by interference, the selecting circuit selects another adjacent pilot cell closest to the predetermined pilot cell to replace the predetermined pilot cell.

5. The channel estimation circuit according to claim 3, wherein the constant quantity of the adjacent pilot cells is N; and when the N adjacent pilot cells include a predetermined pilot cell in a symbol affected by interference, the selecting circuit selects another adjacent pilot cell closest to the data cell to replace the predetermined pilot cell.

6. The channel estimation circuit according to claim 2, wherein the selecting circuit selects from the plurality of adjacent pilot cells the channel information of a non-constant quantity of the adjacent pilot cells as the channel information of the part of the plurality of adjacent pilot cells

7. The channel estimation circuit according to claim 6, wherein a quantity of the part of the adjacent pilot cells changes according to whether a part of the adjacent pilot cells are affected by interference.

8. The channel estimation circuit according to claim 1, wherein the interference indication buffer is an impulsive interference indication buffer, the interference indication information stored therein indicates whether the plurality of symbols are affected by impulsive interference, and the interference indication information is generated according to a noise intensity of the channel information of the plurality of pilot cells.

9. The channel estimation circuit according to claim 1, wherein the plurality of pilot cells are captured from a frequency-domain signal.

10. The channel estimation circuit according to claim 1, wherein the plurality of symbols are orthogonal frequency-division multiplexing (OFDM) symbols.

11. A channel estimation method, comprising:
storing channel information of a plurality pilot cells in a plurality of symbols in a pilot buffer;
storing interference indication information in an interference indication buffer, wherein the interference indication information indicates whether the plurality of symbols are affected by interference; and
estimating, based on the channel information of a part of the plurality of pilot cells stored in the pilot buffer, channel information of a data cell in the plurality of symbols according to the interference indication information, wherein the part of the plurality of pilot cells do not include pilot cells of any symbol affected by interference.

12. The channel estimation method according to claim 11, wherein the step of estimating the channel information of the data cell in the plurality of symbols comprises:
selecting, for the data cell, from the pilot buffer the channel information of a plurality of adjacent pilot cells of the data cell, and referring to the interference indication information stored in the interference indication buffer to select the channel information of a part of the plurality of adjacent pilot cells, wherein the selected part of the adjacent pilot cells do not include pilot cells of any symbol affected by interference; and
performing interpolation according to the channel information of the part of the plurality of adjacent pilot cells to calculate the channel information of the data cell.

13. The channel estimation method according to claim 12, wherein the step of selecting the channel information of the part of the plurality of adjacent pilot cells comprises:
selecting from the plurality of adjacent pilot cells the channel information of a constant quantity of the adjacent pilot cells as the channel information of the part of the plurality of adjacent pilot cells.

14. The channel estimation method according to claim 13, wherein the constant quantity of the adjacent pilot cells is N; and the step of selecting from the plurality of adjacent pilot cells the channel information of the constant quantity of the adjacent pilot cells comprises:
when the N adjacent pilot cells include a predetermined pilot cell of a symbol affected by interference, selecting another adjacent pilot cell closest to the predetermined pilot cell to replace the predetermined pilot cell.

15. The channel estimation method according to claim 13, wherein the constant quantity of the adjacent pilot cells is N; and the step of selecting from the plurality of adjacent pilot cells the channel information of the constant quantity of the adjacent pilot cells comprises:
when the N adjacent pilot cells include a predetermined pilot cell of a symbol affected by interference, selecting another adjacent pilot cell closest to the data cell to replace the predetermined pilot cell.

16. The channel estimation method according to claim 12, wherein the step of selecting the channel information of the part of the plurality of adjacent pilot cells comprises:
selecting from the plurality of adjacent pilot cells the channel information of a non-constant quantity of the adjacent pilot cells as the channel information of the part of the plurality of adjacent pilot cells.

17. The channel estimation method according to claim 16, wherein the quantity of the part of the plurality of adjacent pilot cells changes according to whether a part of the adjacent pilot cells are affected by interference.

18. The channel estimation method according to claim 11, wherein the interference indication buffer is an impulsive interference indication buffer, the interference indication information stored therein indicates whether the plurality of symbols are affected by impulsive interference; the channel estimation method further comprising:
generating the interference indication information according to a noise intensity of the channel information of the plurality of pilot cells.

19. The channel estimation method according to claim 11, further comprising:
capturing the channel information of the plurality pilot cells from a frequency-domain signal.

20. The channel estimation method according to claim 11, wherein the plurality of symbols are orthogonal frequency-division multiplexing (OFDM) symbols.
